(19) United States
(12) Patent Application Publication
(10) Pub. No.: US 2008/0271793 A1
(43) Pub. Date: Nov. 6, 2008

(54) Load-Pressure-Operated Flow Rate Regulator with Vibration Damping

(75) Inventor: Reinhold Schniederjan, Neu-Ulm (DE)

Correspondence Address: SCULLY SCOTT MURPHY & PRESSER, PC, 400 GARDEN CITY PLAZA, SUITE 300, GARDEN CITY, NY, 11530, US

(73) Assignee: BRUENINGHAUS HYDROMATIK GMBH, Elchingen (DE)

(21) Appl. No.: 12/091,595

(22) PCT Filed: Oct. 27, 2006
(86) PCT No.: PCT/EP2006/010378

§ 371 Date: Apr. 25, 2008

(30) Foreign Application Priority Data
Oct. 27, 2005 (DE) 10 2005 051 482.0

(51) Int. Cl. F16K 17/04

(52) U.S. Cl. 137/538

(57) ABSTRACT

The invention relates to a load-pressure-controlled fees flow regulator (1) for adjusting the feed volume of an adjustable hydraulic pump (2) which feeds in a working line (3). The load-pressure-controlled feed flow regulator (1) has an adjusting device (5) for adjusting the feed volume of the hydraulic pump (2). The adjusting device (5) is acted on with an adjusting pressure in order to adjust the feed volume of the hydraulic pump (2). The level of the adjusting pressure is generated by an adjusting pressure regulating device (17). In addition to the adjusting pressure regulating device (17), the fees flow regulator (1) has a damping device (30).

The invention relates to a load-pressure-operated flow rate regulator for adjusting the delivery volume of an adjustable hydraulic pump delivering into a working line.

A load-pressure-operated flow rate regulator is known from DE 197 13 934 A1. To adjust the set delivery volume of a hydraulic pump delivering into a working line, a first and a second hydraulic cylinder are provided. While the first hydraulic cylinder is charged with the delivery pressure generated by the hydraulic pump, the set pressure acting in the second hydraulic cylinder can be set by a control valve. To detect the volume flow delivered by the hydraulic pump, an adjustable throttle is arranged in the working line. The adjustable throttle generates a drop in pressure which is proportional to the volume flow delivered in the working line. The difference in pressure acts on the control valve against the force of a spring. If the difference in pressure exceeds the force of the spring, the second hydraulic cylinder is charged with an increasingly higher set pressure. If, on the other hand, the difference in pressure goes below the force of the spring, the second hydraulic cylinder is relieved of pressure into a tank volume.

In particular when adjusting the hydraulic pump in the direction of increasing pivoting angles, excess vibration arises during the adjustment. Excess vibration of this kind can incite the system, which is already susceptible to vibration per se, to system vibrations.

It is therefore the object of the invention to create a load-operated flow rate regulator with reduced susceptibility to vibration.

The object is achieved by the load-operated flow rate regulator with the features of claim 1. The flow rate regulator according to the invention has an adjusting device for adjusting the delivery volume of the hydraulic pump. To generate a setting movement of the adjusting device, the adjusting device can be charged with a set pressure which can be set according to level. The set pressure acting in the adjusting device is generated by a set pressure regulating device. In addition to the set pressure regulating device the flow rate regulator has a damping device. With the aid of the damping device excess vibration caused by a newly set set pressure is prevented by the set pressure regulating device. The damping device damps the arising volume flow for this purpose and excess vibration of the setting movement in the adjusting device cannot occur.

Advantageous further developments of the load-operated flow rate regulator according to the invention are listed in the subordinate claims.

To damp the arising volume flow, the damping device has a variable throttle cross-section. The variable throttle cross-section is dependent on the volume flow generated in the working line of the hydraulic pump to be adjusted. The throttling cross-section is firstly reduced when the volume flow in the working line approaches a desired value and the volume flow flowing towards the adjusting device is therefore limited. The changing throttle cross-section enables the speed of the hydraulic pump adjustment to be quick at first and slower with increasing approach.

In order to attain high setting accuracy and good regulating characteristics, it is further advantageous to charge a set pressure line charging the adjusting device with a set pressure via the set pressure regulating device, wherein, if a first volume flow limit value is exceeded, the set pressure regulating device connects a delivery pressure connecting line to the set pressure line and thus feeds the delivery pressure generated by the hydraulic pump to the adjusting device. In reverse, if the volume flow generated in the working line drops below the first volume flow limit value, the set pressure line is relieved of pressure in the direction of a tank volume and the set pressure acting in the adjusting device is thus reduced. In order to enable a quick increase in the delivery volume on the part of the hydraulic pump if there is a great divergence of the actual value of the volume flow in the working line from a preset desired value, the connection in the damping device takes place increasingly unthrottled if there is an increasing drop below a second volume flow limit value. Therefore, if there is a great divergence of the volume flow from a preset desired value, quick adjustment can take place. It is particularly advantageous to choose the first volume flow limit value as larger than the second volume flow limit value. Apportioning is therefore increased up to the second volume flow limit value, which is below the desired value for the volume flow.

Furthermore, it is particularly advantageous to enable an unthrottled connection by the damping device if the second volume flow limit value is exceeded by the volume flow in the working line. Regulating the set pressure is therefore done by the set pressure regulating device only in the range immediately surrounding the desired value for the volume flow in the working line and influence by the damping device is prevented. In contrast to the use of damping control edges in the set pressure regulating device itself, this enables exact adjustment of the delivery volume of the hydraulic pump.

It is furthermore advantageous to arrange the damping device in series to the set pressure regulating device. The damping device can in this case be arranged in particular in the set pressure line which connects the set pressure regulating device to the adjusting device. In this way firstly the set pressure regulating device generates a set pressure required for adjusting the hydraulic pump, wherein by the damping device the volume flow arising owing to the set pressure generated is subsequently damped by the damping device and excess vibration thus prevented.

The set pressure regulating device and the damping device are preferably both constructed as pressure-controlled valves. The use of pressure-controlled valves has the advantage that actuation of the two valves of the damping device and of the set pressure regulating device is possible directly by the pressures generated upstream or downstream of a measuring throttle in the working line. Complicated external actuation can therefore be omitted.

The two valves are constructed in a particularly simple manner with a first measuring face and a second measuring face in each case. The first measuring faces are charged with a delivery pressure generated by the hydraulic pump upstream of the measuring throttle and the second measuring faces with the load pressure arising downstream of the measuring throttle.

To generate the damping effect, the valve piston of the valve of the damping device has a section which changes in respect of its cross-sectional area in the axial direction. Instead of a sharp control edge, a flow cross-section changing depending on the position of the valve piston is thus released by the valve piston in its housing. The section of changing cross-sectional area of the valve piston can in the simplest example be constructed as a cone or as a hyperboloid of revolution. However, other geometries are also conceivable as a function of the damping characteristics.

To set the first and the second volume flow limit value, pressure springs preferably act on the second measuring faces of the valves of the damping device and of the set pressure regulating device in addition to the load pressure, the pressure spring acting on the second measuring face of the valve of the damping device having a lower spring constant. It is particularly advantageous to make the pressure springs adjustable, so the regulating characteristics and the response characteristic of the damping device can be changed by adjusting the setting spring.

A preferred embodiment is illustrated in the drawings and is explained in greater detail in the following description.

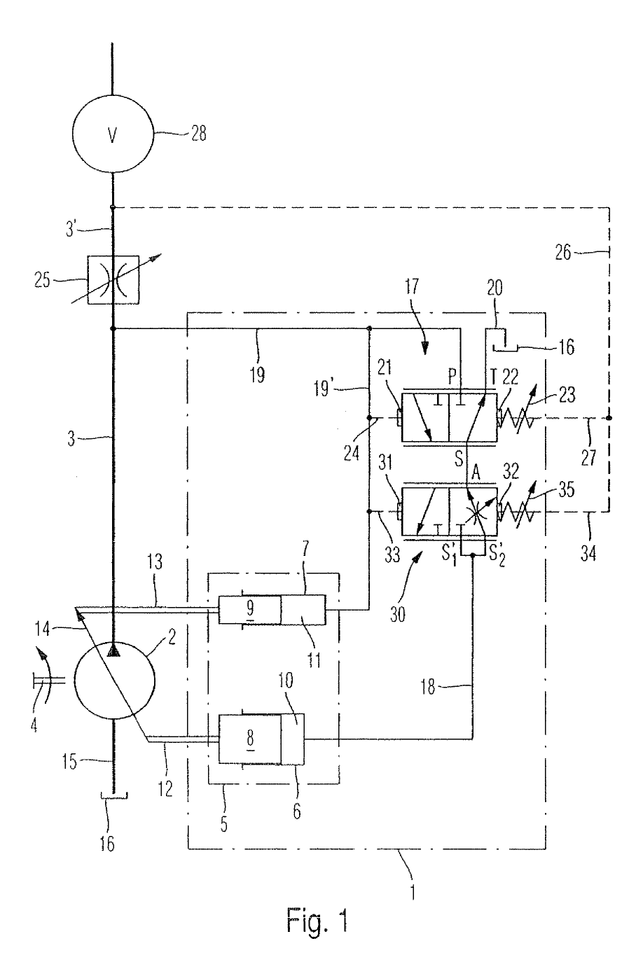

FIG. 1 shows a hydraulic circuit diagram of a load-pressure-operated flow rate regulator according to the invention.

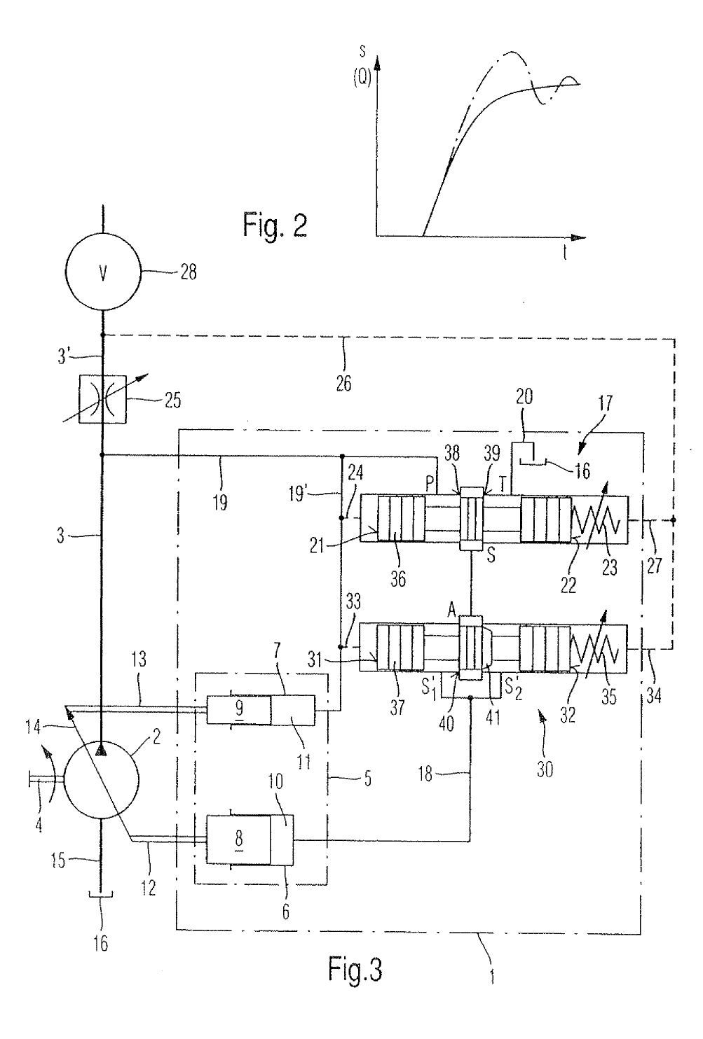

FIG. 2 shows the course of a volume flow from the adjusting device as an example.

FIG. 3 shows an illustration of a structural embodiment of the flow rate regulator according to the invention.

FIG. 1 shows a hydraulic circuit diagram of the flow rate regulator 1 according to the invention. A hydraulic pump 2 whose delivery volume can be set has its delivery volume set to a constant value by the load-pressure-regulated flow rate regulator 1. The adjustable hydraulic pump 2 may be a hydrostatic axial piston machine, for example. In the embodiment example illustrated the adjustable hydraulic pump 2 delivers into a working line 3. The hydraulic pump 2 is driven for this purpose via a drive shaft 4 by a drive machine, not illustrated.

In the embodiment example illustrated the adjusting device 5 has a first hydraulic cylinder 6 and a second hydraulic cylinder 7. In the first hydraulic cylinder 6 a first setting piston 8 is displaceably arranged. Likewise in the second hydraulic cylinder 7 a second setting piston 9 is arranged. The first and the second setting pistons 8, 9 enclose a first set pressure chamber 10 or a second set pressure chamber 11 in the first or second hydraulic cylinder 6, 7. The first setting piston 8 is connected via a first piston rod and the second setting piston 9 via a second piston rod 13 to an adjusting mechanism of the hydraulic pump 2. The two setting pistons 8, 9 thus carry out a setting movement coupled via the adjusting mechanism 14 of the hydraulic pump 2. While in the second set pressure chamber 11 of the second hydraulic cylinder 7 in each case the delivery pressure generated in the working line 3 by the hydraulic pump 2 is applied, the set pressure acting in the first set pressure chamber 10 on the first setting piston 8 can be changed. If the hydraulic force in the first set pressure chamber 10 acting on the first setting piston 8 exceeds the corresponding hydraulic force in the second set pressure chamber 11, the hydraulic pump 2 is adjusted in the direction of decreasing delivery volume.

The hydraulic pump 2 extracts pressure medium from a tank volume 16 via a suction line 15 and delivers it into the working line 3 according to the set delivery volume.

The setting of a specific pivoting angle of the hydraulic pump 2 is done by setting the set pressure acting in the first set pressure chamber 10. A set pressure regulating device, designed as a first valve 17 in the embodiment example illustrated, serves this purpose.

For better understanding, the function of the flow rate regulator is first described below without the damping device according to the invention. By means of the first valve 17 the set pressure line 18 can be connected to a delivery pressure connecting line 19 or a pressure relief line 20. Therefore a set pressure which is between the tank pressure and the delivery pressure prevailing in the working line 3 can be set in the first set pressure chamber 10. The delivery pressure connecting line 19 is additionally connected to the second set pressure chamber 11 via a delivery pressure connecting line branch 19′. The delivery volume of the hydraulic pump 2 is adjusted as a function of the forces generated in the first set pressure chamber 10 and in the second set pressure chamber 11.

The first valve 17 can be adjusted continuously between its first end position and its second end position and adopts a position of equilibrium depending on applied forces. The position of equilibrium of the first valve 17 is established by a hydraulic force on a first measuring face 21, a further hydraulic force of a second measuring face 22 with opposite orientation and the force of a setting spring 23. The force of the setting spring 23 acts on the first valve 17 in the same direction as the hydraulic force on the second measuring face 22.

The hydraulic force on the first measuring face 21 arises from charging of the first measuring face 21 with the delivery pressure which is fed from the working line 3 via the delivery pressure connecting line 19, the delivery pressure connecting line branch 19′ and a first measuring line section 24. In the opposite direction the force of the setting spring 23 and the hydraulic force on the second measuring face 22, which is charged by a load pressure, acts on the first valve 17. The load pressure is taken from a working line section 3′ downstream of a, preferably settable, measuring throttle 25 via a load pressure line 26 and fed to the second measuring face 22 via a second measuring line section 27.

The measuring throttle 25 generates a difference in pressure in the working line 3 which is proportional to the volume flow in the working line 3, which is fed to a consumer 28. While the delivery pressure generated by the hydraulic pump 2 acts on the first measuring face 21 of the first valve 17, the load pressure prevailing downstream of the measuring throttle 25 acts in the opposite direction on the second measuring face 22. Therefore a resulting force corresponding to the volume flow delivered by the hydraulic pump 2 acts on the first valve 17 against the setting spring 23.

The setting spring 23 thus establishes a first volume flow limit value for the first valve 17. If the volume flow through the measuring throttle 25 exceeds the first volume flow limit value, the control valve 17 is moved out of its first end position illustrated in FIG. 1 in the direction of its second end position and thus the set pressure line 18 is increasingly connected to the first delivery pressure connecting line 19.

If the volume flow in the working line 3 drops below the first volume flow limit value, the first valve 17 is adjusted back by the force of the setting spring 23 in the direction of its first end position, in which the set pressure port S of the first valve 17 is connected to the tank port T and thus the set pressure line 18 is relieved of pressure into the tank volume 16 via the pressure relief line 20. Because of the pressure relief of the first set pressure chamber 10 the pressure acting on a piston face of the first setting piston 8 is reduced and the hydraulic pump 2 is swiveled out by the delivery pressure acting in the second hydraulic cylinder in the direction of larger delivery volume. This may cause an undesirably large increase in the set delivery volume which may stimulate the entire system of the flow rate regulator 1 to vibrate.

A regulating characteristic of this kind, as known from conventional flow rate regulators, is illustrated as an example in FIG. 2 as a dot and dash line. According to the invention, in order to achieve the course shown by the continuous line in FIG. 2, a second valve 30 is provided as damping device, with which an excessively sharp increase in the volume flow out of the first set pressure chamber 10 in the direction of the tank volume 16 is prevented.

The second valve 30 likewise has a first measuring face 31 and a second measuring face 32. The delivery pressure fed via the delivery pressure connecting line 19 and the delivery pressure connecting line section 19′ acts on the first measuring face 31 of the second valve 30 via a third measuring line section 33. In the opposite direction the load pressure which is fed to the working line section 3′ downstream of the measuring throttle 25 via the load pressure line 26 and a fourth measuring line section 34 acts on the valve 30 on the second measuring face 32. The force of a second setting spring 35, by which the response limit of the second valve 30 is established as second volume flow limit value, acts in the same direction as the hydraulic force on the second measuring face 32. By means of the second setting spring 35 a second volume flow limit value is established for the second valve 30, which is preferably smaller than the first volume flow limit value of the first valve 17.

The second valve 30, like the first valve 17, is a 3/2-port directional control valve. While a first port A of the second valve 30 is connected to the set pressure port S of the first valve 17, the second and third ports S′₁ and S′₂ of the second valve 30 are connected to the set pressure line 18 in each case. In FIG. 1 the second valve 30 is illustrated in its first end position. In the first end position the third port S′₂ is connected to the first port A slightly throttled. With volume flow increasing in the direction of the first volume flow limit value in the working line 3, the second valve 30 is increasingly adjusted in the direction of its second end position. The connection between the third port S′₂ and the first port A of the second valve 30 is in this case increasingly throttled. If there is an increase in volume flow in the working line 3 above the second low volume flow limit value, the resulting force exceeds the force of the second setting spring 35, owing to the difference in pressure between the delivery pressure and the load pressure, and the second valve 30 is adjusted in the direction of its second end position, in which there is an unthrottled connection between the first port A and the second port S′₁.

This switching position is reached before the volume flow desired value, established as the first volume flow limit value by the first setting spring 23 and the first valve 17, is reached in the working line 3. This ensures that the influence of the second valve 30, which damps the swivelling out movement of the hydraulic pump 2, has no influence on reaching the target setting of the hydraulic pump 2. The damping device does not have a function in the range around the first volume flow limit value preset by the first setting spring 23, owing to the unthrottled connection of the set pressure port S to the set pressure line 18.

If the volume flow in the working line 3 increases further, the difference in pressure between the delivery and the load pressure also increases. Accordingly, the second valve 30 is held in its second end position. No throttling of the volume flow in the set pressure line 18 takes place, so swivelling back of the hydraulic pump 2 may take place at any speed, in contrast to the swivelling out of the hydraulic pump 2. Therefore if the volume flow in the working line 3 exceeds the first volume flow limit value preset by the setting spring 23, the set pressure port S is connected by the first valve 17 to the delivery pressure port P and the first set pressure chamber 10 is charged with the delivery pressure without damping influence of the second valve 30. Quick adjustment of the hydraulic pump 2 in the direction of smaller pivoting angles can therefore take place.

FIG. 3 illustrates a structural embodiment example of the load-pressure-regulated flow rate regulator 1 according to the invention. The first valve 17 and the second valve 30 each have a valve piston 36 or 37. Constructed on the valve piston 36 of the first valve 17 by areas of radially reduced dimension are a first control edge 28 and a second control edge 39. The valve piston 36 of the first valve 17 is illustrated in its central position, in which ports P, S and T are separated from one another by the control edges 38, 39. If valve piston 36 of the first valve 17 is moved out of this central position in one of the two directions, control edge 38 or control edge 39 release a connection between the delivery pressure port P or the tank port T and the set pressure port S, which can be flowed through. Because of the sudden increase in the diameter to form the control edges 38 and 39, a displacement of the valve piston 36 in its housing causes a virtually unthrottled connection of the respective ports P, S or S, T.

In contrast to this, only one sharply defined control edge 40 is constructed on valve piston 37 of valve 30. Valve piston 37 of the second valve 30 is likewise illustrated in its central position. As long as the volume flow in the working line 3 is greater than the second volume flow limit value, a connection which can be flowed through unthrottled is produced from the first port A to the second port S′₁ by means of the control edge 40 of valve piston 37 of the second valve 30. In contrast to this, in the case of a reverse direction of movement, in other words if the volume flow in the working line 3 drops below the second volume flow limit value, a steady increase in the cross-section which can be flowed through in the second valve 30 is achieved.

FIG. 3 illustrates how a section 41 is constructed on valve piston 37 of the second valve 30 for this purpose, which in the axial direction has a change of cross-sectional area. In the embodiment example illustrated section 41 is constructed as a truncated cone, so with increasing movement of valve piston 37 of the second valve 30 in the direction of its first end position an increasingly larger cross-sectional area is released for flowing through. This means that if the volume flow in the working line 3 drops a long way below the second volume flow limit value, a large cross-section which can be flowed through is released by section 41. Simultaneously valve piston 36 of the first valve 17 is likewise deflected in the direction of its second end position and the first set pressure chamber 10 is quickly relieved of pressure into the tank volume 16 via the set pressure line 18 and the second valve 30 and the first valve 17 and the pressure relief line 20.

If the volume flow in the working line 3 approaches the second volume flow limit value because of the increasing swivelling out of the hydraulic pump 2 and the thus increasing delivery volume of the hydraulic pump 2, valve piston 37 of the second valve 30 moves increasingly in the direction of its second end position. Owing to the conical design of section 41, the cross-section which can be flowed through is thus reduced between the first port A and the third port S′₂ and the volume flow flowing out of the first set pressure chamber 10 in the direction of the tank volume 16 is reduced. A noticeable throttling takes place preferably on the last third of the setting path. This effectively prevents excess vibration during adjusting of the hydraulic pump 2 in the direction of greater delivery volume. If the volume flow in the working line 3 becomes greater than the second volume flow limit value set by the second setting spring 35 because of the adjustment of the hydraulic pump 2 in the direction of increasing delivery volume, valve piston 37 in FIG. 3 is illustrated to the right and the second valve is thus adjusted in the direction of its second end position. In this second end position an unthrottled connection is constructed between the first port A and the second port S′₁.

A further increase in the delivery volume in the working line 3 causes valve piston 37 of the second valve 30 to be held in its second end position. Simultaneously the flow volume approaches the first, higher volume flow limit value because of further pressure relief of the first set pressure chamber 10. In this range, regulating the set pressure takes place in the first set pressure chamber 10 by the first valve 17 only. Thus exact setting of the set pressure in the first set pressure chamber 10 and thus exact positioning of the adjusting mechanism 14 for setting the delivery volume of the hydraulic pump 2 can take place.

A further increase in the delivery volume in the working line 3 results in an adjustment of valve piston 36 of the first valve 17, so the delivery pressure port P is connected to the set pressure port S by the first control edge 38. The second valve 30 is still in its second end position, so no throttling of the volume flow prevailing in the set pressure line 18 takes place. If there is a reduction in the delivery volume of the hydraulic pump 2 there is likewise no damping by the second valve 30. Adjustment of the hydraulic pump 2 in the direction of smaller pivoting angles thus takes place simply according to the regulating characteristics of the first valve 17.

Various geometries of valve piston 37 in section 41 are conceivable as a function of the desired regulating characteristics during swivelling out of the hydraulic pump 2. In FIG. 3 a section 41 in the shape of a truncated cone is illustrated as the simplest embodiment example. It is likewise conceivable to embody section 41 as a hyperboloid of revolution, for example, or with throttling indentations.

The invention is not confined to the embodiment examples illustrated but also comprises the combination of individual features illustrated in the figures.

1. Load-pressure-operated flow rate regulator for adjusting the delivery volume of an adjustable hydraulic pump delivering into a working line, with an adjusting device for adjusting the delivery volume of the hydraulic pump, the adjusting device being charged with a set pressure, and a set pressure regulating device for generating a set pressure wherein the flow rate regulator has a damping device.

2. Load-pressure-operated flow rate regulator according to claim 1, wherein the damping device has a throttle cross-section dependent on a volume flow in the working line.

3. Load-pressure-operated flow rate regulator according to claim 1, wherein a set pressure line is connected to a delivery pressure connecting line by the set pressure regulating device if a first volume flow limit value is exceeded and the set pressure line is relieved of pressure if there is a drop below the first volume flow limit value and in that the damping device can be flowed through increasingly unthrottled if there is an increasing drop below a second volume flow limit value.

4. Load-pressure-operated flow rate regulator according to claim 3, wherein the first volume flow limit value is greater than the second volume flow limit value.

5. Load-pressure-operated flow rate regulator according to claim 3, wherein the damping device can be flowed through unthrottled if the second volume flow limit value is exceeded.

6. Load-pressure-operated flow rate regulator according to claim 1, wherein the damping device is arranged in the set pressure line.

7. Load-pressure-operated flow rate regulator according to claim 1, wherein the set pressure regulating device and the damping device are constructed as pressure-controlled valves.

8. Load-pressure-operated flow rate regulator according to claim 7, wherein the valves each have a valve piston with a first measuring face and a second measuring face in each case, wherein the first measuring faces are charged with a delivery pressure prevailing upstream of a measuring throttle and the second measuring faces with a load pressure prevailing downstream of the measuring throttle.

9. Load-pressure-operated flow rate regulator according to claim 7, wherein the valve piston of the valve of the damping device has a section with a cross-sectional area which changes in the axial direction.

10. Load-pressure-operated flow rate regulator according to claim 9, wherein the section with a cross-sectional area of the valve piston which changes in the axial direction is constructed as conical or as a hyperboloid of revolution.

11. Load-pressure-operated flow rate regulator according to claim 7, wherein a spring acts on the second measuring faces of the valves in each case and the spring of the valve of the damping device has a lower spring constant.
